(19) United States
(12) Patent Application Publication
(10) Pub. No.: US 2024/0169377 A1
(43) Pub. Date: May 23, 2024

(54) DEMAND PREDICTION DEVICE AND DEMAND PREDICTION METHOD

(71) Applicant: Mitsubishi Electric Corporation, Tokyo (JP)

(72) Inventors: Takasumi KOBE, Tokyo (JP); Ryo MATSUMURA, Tokyo (JP)

(73) Assignee: Mitsubishi Electric Corporation, Tokyo (JP)

(21) Appl. No.: 18/424,434

(22) Filed: Jan. 26, 2024

Related U.S. Application Data
(63) Continuation of application No. PCT/JP2021/035737, filed on Sep. 29, 2021.

(51) Int. Cl. G06Q 30/0202

(52) U.S. Cl. CPC G06Q 30/0202

(57) ABSTRACT

A demand prediction device includes processing circuitry configured to; acquire demand data indicating a temporal change of a past demand in a product of a demand prediction target and index candidate data indicating each of a plurality of indexes which are candidates of an index related to the past demand; calculate a relevance degree between at least one index indicated by each of index candidate data having been acquired and a demand indicated by the demand data having been acquired; extract index data used for demand prediction processing for predicting a future demand of the product from among the plurality of index candidate data having been acquired on a basis of the calculated relevance degree; perform the demand prediction processing using the extracted index data.

### CROSS REFERENCE TO RELATED APPLICATION

This application is a Continuation of PCT International Application No. PCT/JP2021/035737, filed on Sep. 29, 2021, all of which is hereby expressly incorporated by reference into the present application.

### TECHNICAL FIELD

The present disclosure relates to a demand prediction device and a demand prediction method.

### BACKGROUND ART

It is important for a company or the like to predict future demand for a product in order to produce a product, sell a product, or the like. There is a demand prediction device that gives one or more economic indexes related to a demand of a product to an analytical model and obtains a prediction result of a future demand of the product from the analytical model (see Patent Literature 1). Examples of the economic index include a diffusion index, an average stock price, and a fuel price.

### CITATION LIST

### Patent Literature

Patent Literature 1: JP 2015-118412 A

### SUMMARY OF INVENTION

### Technical Problem

In the demand prediction device disclosed in Patent Literature 1, one or more economic indexes given to the analytical model may include not only an economic index having a high relevance degree to the demand of the product but also an economic index having a low relevance degree. When an economic index having a low relevance degree is included, there is a problem that the prediction result of the demand by the analytical model may deviate from the future demand of the product.

The present disclosure has been made to solve the problems as described above, and an object of the present disclosure is to provide a demand prediction device and a demand prediction method capable of preventing a prediction result of a demand from deviating from a future demand of a product even when index candidate data indicating an index having a low relevance degree with the demand of the product is included in a plurality of pieces of index candidate data provided to the demand prediction device.

### Solution to Problem

A demand prediction device according to the present disclosure includes: processing circuitry configured to acquire demand data indicating a temporal change of a past demand in a product of a demand prediction target and index candidate data indicating each of a plurality of indexes which are candidates of an index related to the past demand; calculate a relevance degree between at least one index indicated by each of index candidate data having been acquired and a demand indicated by the demand data having been acquired; extract index data used for demand prediction processing for predicting a future demand of the product from among the plurality of index candidate data having been acquired on a basis of the calculated relevance degree; perform the demand prediction processing using the extracted index data; acquire setting data indicating a semantic similarity corresponding to a similarity degree between the at least one index indicated by each of the index candidate data and the demand indicated by the demand data in addition to the plurality of index candidate data and the demand data; and calculate a correlation coefficient between each of the index candidate data and the demand data or a distance between each of the index candidate data and the demand data, and calculate the relevance degree between the at least one index indicated by each of the index candidate data and the demand indicated by the demand data from each correlation coefficient or each distance and the semantic similarity indicated by the setting data.

### Advantageous Effects of Invention

According to the present disclosure, it is possible to prevent a prediction result of a demand from deviating from a future demand of a product even when index candidate data indicating an index having a low relevance degree with the demand of the product is included in a plurality of index candidate data provided to the demand prediction device.

### BRIEF DESCRIPTION OF DRAWINGS

FIG. 1 is a configuration diagram illustrating a demand prediction system 1 including a demand prediction device 4 according to a first embodiment.

FIG. 2 is a configuration diagram illustrating a decision making support device 2 and the demand prediction device 4 according to the first embodiment.

FIG. 3 is a hardware configuration diagram illustrating hardware of the demand prediction device 4 according to the first embodiment.

FIG. 4 is a hardware configuration diagram of a computer in a case where the demand prediction device 4 is implemented by software, firmware, or the like.

FIG. 5 is a configuration diagram illustrating a learning device 3 and the demand prediction device 4 according to the first embodiment.

FIG. 6 is a hardware configuration diagram illustrating hardware of the learning device 3 according to the first embodiment.

FIG. 7 is a hardware configuration diagram of a computer in a case where the learning device 3 is implemented by software, firmware, or the like.

FIG. 8 is a flowchart illustrating a demand prediction method which is a processing procedure of the demand prediction device 4.

FIG. 9 is an explanatory diagram illustrating an example of index candidate data.

FIG. 10 is a flowchart illustrating a processing procedure of the learning device 3.

FIG. 11 is an explanatory diagram illustrating an input and output relationship of one prediction model.

FIG. 12 is a configuration diagram illustrating a decision making support device 2 and a demand prediction device 4 according to a second embodiment.

FIG. 13 is a hardware configuration diagram illustrating hardware of the demand prediction device 4 according to the second embodiment.

FIG. 14 is an explanatory diagram illustrating an example of setting data B.

FIG. 15 is a configuration diagram illustrating a decision making support device 2 and a demand prediction device 4 according to a third embodiment.

FIG. 16 is a hardware configuration diagram illustrating hardware of the demand prediction device 4 according to the third embodiment.

### DESCRIPTION OF EMBODIMENTS

In order to explain the present disclosure in more detail, a mode for carrying out the present disclosure will be described below with reference to the accompanying drawings.

### First Embodiment

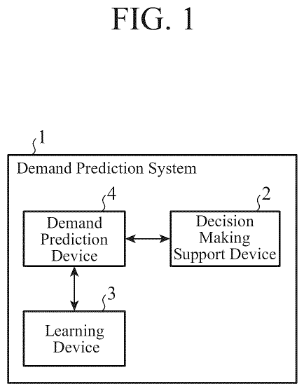

FIG. 1 is a configuration diagram illustrating a demand prediction system 1 including a demand prediction device 4 according to a first embodiment.

The demand prediction system 1 illustrated in FIG. 1 includes a decision making support device 2, a learning device 3, and a demand prediction device 4.

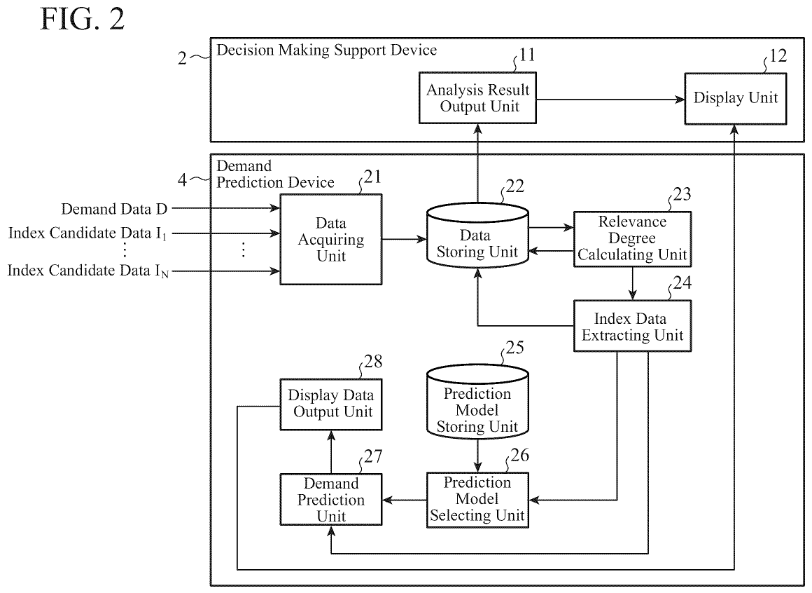

FIG. 2 is a configuration diagram illustrating the decision making support device 2 and the demand prediction device 4 according to the first embodiment.

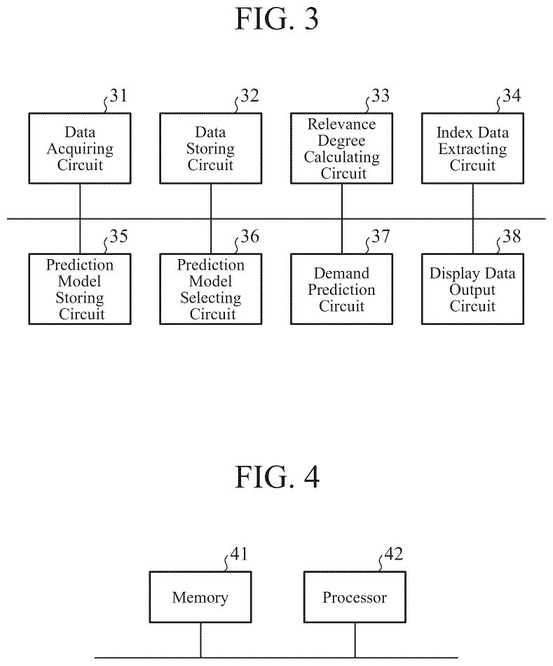

FIG. 3 is a hardware configuration diagram illustrating hardware of the demand prediction device 4 according to the first embodiment.

The decision making support device 2 includes an analysis result output unit 11 and a display unit 12. The analysis result output unit 11 and the display unit 12 will be described later.

The learning device 3 generates a prediction model used for demand prediction processing of the demand prediction device 4.

The demand prediction device 4 includes a data acquiring unit 21, a data storing unit 22, a relevance degree calculating unit 23, an index data extracting unit 24, a prediction model storing unit 25, a prediction model selecting unit 26, a demand prediction unit 27, and a display data output unit 28.

The data acquiring unit 21 is implemented by, for example, a data acquiring circuit 31 illustrated in FIG. 3.

The data acquiring unit 21 acquires demand data D indicating a temporal change in the past demand in the demand prediction target product. The demand data D is, for example, time-series data indicating the demand at a plurality of times included in a period TP1.

In addition, the data acquiring unit 21 acquires index candidate data Iₙ (n=1, . . . , N) indicating each of N indexes that are candidates of the index related to the past demand indicated by the demand data D. N is an integer of 2 or more. The index candidate data Iₙ is, for example, time-series data indicating indexes at a plurality of times included in a period TP2.

In the demand prediction device 4 illustrated in FIG. 2, the period TP1 related to the demand data D may be the same period as the period TP2 related to the index candidate data Iₙ, or the period TP1 related to the demand data D may be a future period ahead of the period TP2 related to the index candidate data Iₙ.

When the period TP1 related to the demand data D is a future period ahead of the period TP2 related to the index candidate data Iₙ, the demand data D is data time-shifted with respect to the index candidate data Iₙ. If the time shift is, for example, two months and the period TP2 related to the index candidate data Iₙ is the period from August 1 to August 31, the period TP1 related to the demand data D is the period from October 1 to October 31.

Here, an example is illustrated in which all the periods relating to the index candidate data I₁ to I_{N} are TP2. However, this is merely an example, and the periods relating to the index candidate data I₁ to I_{N} may be different from each other.

The data acquiring unit 21 outputs each piece of the index candidate data I₁ to I_{N} and the demand data D to the data storing unit 22.

The data storing unit 22 is implemented by, for example, a data storing circuit 32 illustrated in FIG. 3.

The data storing unit 22 stores each piece of the index candidate data I₁ to I_{N} and the demand data D output from the data acquiring unit 21.

The relevance degree calculating unit 23 is implemented by, for example, a relevance degree calculating circuit 33 illustrated in FIG. 3.

The relevance degree calculating unit 23 acquires, from the data storing unit 22, the index candidate data Iₙ (n=1, . . . , N) acquired by the data acquiring unit 21 and the demand data D acquired by the data acquiring unit 21.

The relevance degree calculating unit 23 calculates a relevance degree Cₙ (n=1, . . . , N) between the index indicated by the index candidate data Iₙ (n=1, . . . , N) and the demand indicated by the demand data D.

The relevance degree calculating unit 23 outputs each of the index candidate data Iₙ (n=1, . . . , N), the demand data D, and the relevance degree Cₙ to the index data extracting unit 24.

The relevance degree calculating unit 23 also outputs the relevance degree Cₙ to the data storing unit 22.

The index data extracting unit 24 is implemented by, for example, an index data extracting circuit 34 illustrated in FIG. 3.

The index data extracting unit 24 acquires each of the index candidate data Iₙ (n=1, . . . , N), the demand data D, and the relevance degree Cₙ from the relevance degree calculating unit 23.

Based on the relevance degree Cₙ, the index data extracting unit 24 extracts index data Iₘ′ (m=1, . . . , M) used for demand prediction processing for predicting future demand of a product from among the N pieces of index candidate data I₁ to I_{N}. M is an integer of 1 or more and N or less.

The index data extracting unit 24 outputs the demand data D to the prediction model selecting unit 26.

In addition, the index data extracting unit 24 outputs the index data Iₘ′ (m=1, . . . , M) to each of the demand prediction unit 27 and the data storing unit 22.

The prediction model storing unit 25 is implemented by, for example, a prediction model storing circuit 35 illustrated in FIG. 3.

The prediction model storing unit 25 stores the G prediction models PM₁ to PM_{G} generated by the learning device 3.

The prediction model selecting unit 26 is implemented by, for example, a prediction model selecting circuit 36 illustrated in FIG. 3.

The prediction model selecting unit 26 acquires the demand data D from the index data extracting unit 24.

Based on the demand data D, the prediction model selecting unit 26 selects a prediction model PM to which the index data Iₘ′ is given from among the G prediction models PM₁ to PM_{G} stored in the prediction model storing unit 25. G is an integer of 1 or more.

If G=1 and the number of prediction models PM stored in the prediction model storing unit 25 is 1, the prediction model selecting unit 26 is unnecessary.

The demand prediction unit 27 is implemented by, for example, a demand prediction circuit 37 illustrated in FIG. 3.

The demand prediction unit 27 acquires the index data Iₘ′ (m=1, . . . , M) from the index data extracting unit 24.

The demand prediction unit 27 performs demand prediction processing using the index data Iₙ′ (m=1, . . . , M).

That is, the demand prediction unit 27 gives the index data I₁′ to I_{M}′ to the prediction model PM selected by the prediction model selecting unit 26, and performs demand prediction processing of acquiring a prediction result R of the future demand of the product from the prediction model PM.

The demand prediction unit 27 outputs the prediction result R of the demand to the display data output unit 28.

The display data output unit 28 is implemented by, for example, a display data output circuit 38 illustrated in FIG. 3.

The display data output unit 28 acquires the prediction result R of the demand from the demand prediction unit 27.

The display data output unit 28 generates display data H for displaying the prediction result R of the demand, and outputs the display data H to the display unit 12.

The analysis result output unit 11 of the decision making support device 2 acquires, from the data storing unit 22, the index data Iₘ′ (m=1, . . . , M) to be used in the demand prediction processing and the demand data D acquired by the data acquiring unit 21, which are output from the index data extracting unit 24.

The analysis result output unit 11 outputs each of the index data Iₘ′ (m=1, . . . , M) and the demand data D to the display unit 12.

The display unit 12 displays the prediction result R of the demand on the display according to the display data H output from the display data output unit 28.

In addition, the display unit 12 displays each of the index data Iₘ′ to I_{M}′ and the demand data D on the display.

In FIG. 2, it is assumed that each of the data acquiring unit 21, the data storing unit 22, the relevance degree calculating unit 23, the index data extracting unit 24, the prediction model storing unit 25, the prediction model selecting unit 26, the demand prediction unit 27, and the display data output unit 28, which are components of the demand prediction device 4, is implemented by dedicated hardware as illustrated in FIG. 3. That is, it is assumed that the demand prediction device 4 is implemented by the data acquiring circuit 31, the data storing circuit 32, the relevance degree calculating circuit 33, the index data extracting circuit 34, the prediction model storing circuit 35, the prediction model selecting circuit 36, the demand prediction circuit 37, and the display data output circuit 38.

Here, each of the data storing circuit 32 and the prediction model storing circuit 35 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

In addition, each of the data acquiring circuit 31, the relevance degree calculating circuit 33, the index data extracting circuit 34, the prediction model selecting circuit 36, the demand prediction circuit 37, and the display data output circuit 38 corresponds to, for example, a single circuit, a composite circuit, a programmed processor, a parallel-programmed processor, an application specific integrated circuit (ASIC), a field-programmable gate array (FPGA), or a combination thereof

The components of the demand prediction device 4 are not limited to those implemented by dedicated hardware, and the demand prediction device 4 may be implemented by software, firmware, or a combination of software and firmware.

Software or firmware is stored in a memory of a computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

FIG. 4 is a hardware configuration diagram of a computer in a case where the demand prediction device 4 is implemented by software, firmware, or the like.

In a case where the demand prediction device 4 is implemented by software, firmware, or the like, the data storing unit 22 and the prediction model storing unit 25 are configured on a memory 41 of a computer. A program for causing a computer to execute each processing procedure in the data acquiring unit 21, the relevance degree calculating unit 23, the index data extracting unit 24, the prediction model selecting unit 26, the demand prediction unit 27, and the display data output unit 28 is stored in the memory 41. Then, a processor 42 of the computer executes the program stored in the memory 41.

In addition, FIG. 3 illustrates an example in which each of the components of the demand prediction device 4 is implemented by dedicated hardware, and FIG. 4 illustrates an example in which the demand prediction device 4 is implemented by software, firmware, or the like. However, this is merely an example, and some components in the demand prediction device 4 may be implemented by dedicated hardware, and the remaining components may be implemented by software, firmware, or the like.

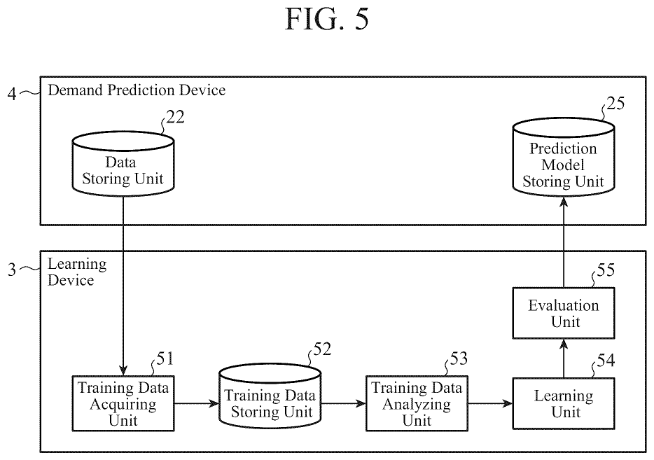

FIG. 5 is a configuration diagram illustrating the learning device 3 and the demand prediction device 4 according to the first embodiment.

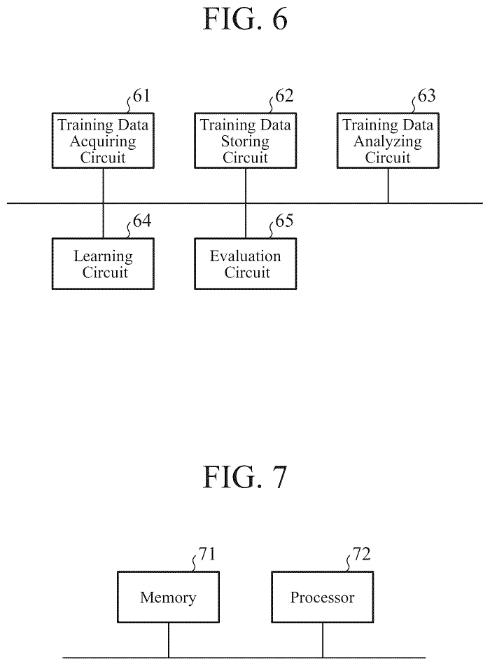

FIG. 6 is a hardware configuration diagram illustrating hardware of the learning device 3 according to the first embodiment.

In FIG. 5, in order to simplify the drawing, description of components other than the data storing unit 22 and the prediction model storing unit 25 in the demand prediction device 4 is omitted.

The learning device 3 illustrated in FIG. 5 includes a training data acquiring unit 51, a training data storing unit 52, a training data analyzing unit 53, a learning unit 54, and an evaluation unit 55.

The training data acquiring unit 51 is implemented by, for example, a training data acquiring circuit 61 illustrated in FIG. 6.

The training data acquiring unit 51 acquires index candidate data Iₙ (n=1, . . . , N) and demand data D as training data from the data storing unit 22.

The demand data D acquired by the training data acquiring unit 51 is, for example, time-series data indicating the demand at a plurality of times included in a period TP1′.

In addition, the index candidate data L acquired by the training data acquiring unit 51 is, for example, time-series data indicating indexes at a plurality of times included in a period TP2′.

Each of the index candidate data L and the demand data D acquired by the training data acquiring unit 51 is past data compared with each of the index candidate data L and the demand data D given to the demand prediction device 4 when the demand prediction processing is performed by the demand prediction device 4.

In the learning device 3 illustrated in FIG. 5, the period TP1′ related to the demand data D is a future period with respect to the period TP2′ related to the index candidate data Iₙ. That is, the demand data D is data that is time-shifted with respect to the index candidate data Iₙ. If the time shift is, for example, two months and the period TP2′ related to the index candidate data Iₙ is the period from August 1 to August 31, the period TP1′ related to the demand data D is the period from October 1 to October 31.

Here, an example is illustrated in which all the periods relating to the index candidate data I₁ to I_{N} are TP2′. However, this is merely an example, and the periods relating to the index candidate data I₁ to I_{N} may be different from each other.

The training data acquiring unit 51 outputs each of the index candidate data Iₙ (n=1, . . . , N) and the demand data D to the training data storing unit 52.

The training data storing unit 52 is implemented by, for example, a training data storing circuit 62 illustrated in FIG. 6.

The training data storing unit 52 stores each of the index candidate data Iₙ (n=1, . . . , N) and the demand data D output from the training data acquiring unit 51.

The training data analyzing unit 53 is implemented by, for example, a training data analyzing circuit 63 illustrated in FIG. 6.

The training data analyzing unit 53 calculates a relevance degree Cₙ (n=1, . . . , N) between the index indicated by the index candidate data Iₙ (n=1, . . . , N) and the demand indicated by the demand data D.

The training data analyzing unit 53 extracts index data Iⱼ″ (j=1, . . . , J) used for generating a prediction model from among the N pieces of index candidate data Ii to IN on the basis of the relevance degree Cₙ. J is an integer of 1 or more and N or less.

The training data analyzing unit 53 outputs each of the extracted index data Iⱼ″ (j=1, . . . , J) and demand data D to the learning unit 54.

The learning unit 54 is implemented by, for example, a learning circuit 64 illustrated in FIG. 6.

The learning unit 54 acquires each of the index data Iⱼ″ (j=1, . . . , J) and the demand data D from the training data analyzing unit 53.

The learning unit 54 generates Q prediction models using each of the index data Iⱼ″ (j=1, . . . , J) and the demand data D. Q is an integer of 1 or more and G or less.

Examples of the prediction model generated by the learning unit 54 include an autoregressive model, a moving average model, an autoregressive moving average model, an autoregressive integrated moving average model, and a seasonal autoregressive moving average model. These prediction models are models in which demand prediction is performed by time series analysis.

Furthermore, the prediction model generated by the learning unit 54 may be a model in which demand prediction is performed by multivariate analysis such as regression analysis, cluster analysis, or multidimensional scaling.

Furthermore, the prediction model generated by the learning unit 54 may be a model in which demand prediction is performed by a method in which time series analysis and multivariate analysis are combined, or may be a model in which demand prediction is performed by Bayesian estimation, a sigma method, or a state space model.

The evaluation unit 55 is implemented by, for example, an evaluation circuit 65 illustrated in FIG. 6.

The evaluation unit 55 evaluates each of the Q prediction models generated by the learning unit 54.

The evaluation unit 55 specifies the top G prediction models PM₁ to PM_{G} having relatively high evaluation among the Q prediction models.

The evaluation unit 55 outputs the G prediction models PM₁ to PM_{G} to the prediction model storing unit 25.

In FIG. 5, it is assumed that each of the training data acquiring unit 51, the training data storing unit 52, the training data analyzing unit 53, the learning unit 54, and the evaluation unit 55, which are components of the learning device 3, is implemented by dedicated hardware as illustrated in FIG. 6. That is, it is assumed that the learning device 3 is implemented by the training data acquiring circuit 61, the training data storing circuit 62, the training data analyzing circuit 63, the learning circuit 64, and the evaluation circuit 65.

Here, the training data storing circuit 62 corresponds to, for example, a nonvolatile or volatile semiconductor memory such as RAM, ROM, a flash memory, EPROM, or EEPROM, a magnetic disk, a flexible disk, an optical disk, a compact disk, a mini disk, or DVD.

Furthermore, each of the training data acquiring circuit 61, the training data analyzing circuit 63, the learning circuit 64, and the evaluation circuit 65 corresponds to, for example, a single circuit, a composite circuit, a programmed processor, a parallel-programmed processor, ASIC, FPGA, or a combination thereof.

The components of the learning device 3 are not limited to those implemented by dedicated hardware, and the learning device 3 may be implemented by software, firmware, or a combination of software and firmware.

FIG. 7 is a hardware configuration diagram of a computer in a case where the learning device 3 is implemented by software, firmware, or the like.

In a case where the learning device 3 is implemented by software, firmware, or the like, the training data storing unit 52 is configured on a memory 71 of the computer. A program for causing a computer to execute each processing procedure in the training data acquiring unit 51, the training data analyzing unit 53, the learning unit 54, and the evaluation unit 55 is stored in the memory 71. Then, a processor 72 of the computer executes the program stored in the memory 71.

In addition, FIG. 6 illustrates an example in which each of the components of the learning device 3 is implemented by dedicated hardware, and FIG. 7 illustrates an example in which the learning device 3 is implemented by software, firmware, or the like. However, this is merely an example, and some components in the learning device 3 may be implemented by dedicated hardware, and the remaining components may be implemented by software, firmware, or the like.

Next, the operation of the demand prediction device 4 illustrated in FIG. 2 will be described.

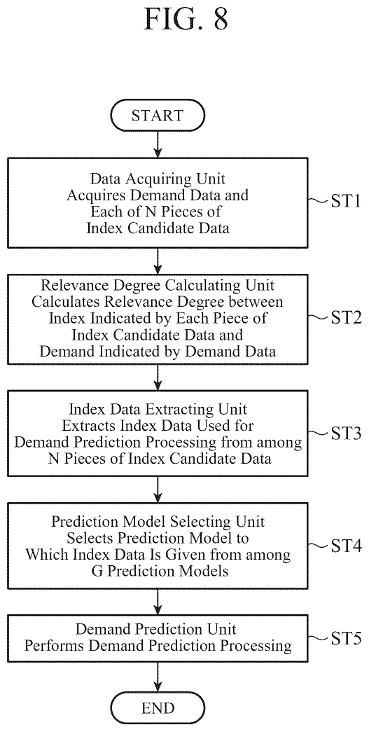

FIG. 8 is a flowchart illustrating a demand prediction method which is a processing procedure of the demand prediction device 4.

The data acquiring unit 21 acquires demand data D indicating a temporal change in the past demand in the demand prediction target product (step ST1 in FIG. 8).

Examples of the demand data D include data indicating a temporal change in an actual value of a shipment amount of a product, an actual value of an inventory amount of a product, an actual value of an order-placing amount of a product, an actual value of an order-receiving amount of a product, or an actual value of a production amount of a product.

In addition, the data acquiring unit 21 acquires index candidate data Iₙ (n=1, . . . , N) indicating each of the N indexes that are candidates of the index related to the past demand indicated by the demand data D (step ST1 in FIG. 8). N is an integer of 2 or more.

Examples of the index candidate data Iₙ include data indicating a temporal change in an economic index, a statistical index, or weather information. In addition, examples of the index candidate data Iₙ include, for example, the number of operated devices using the product within a period in which the demand data D of the product is obtained.

Examples of the economic index include a stock price of a company related to a product, a gross domestic product (GDP) of a trading partner, an exchange rate with the trading partner, indexes of business conditions, an average stock price, or a fuel price.

Examples of the statistical index include an index indicating a production amount or a sales amount of a raw material related to a product, and trade related information of a product.

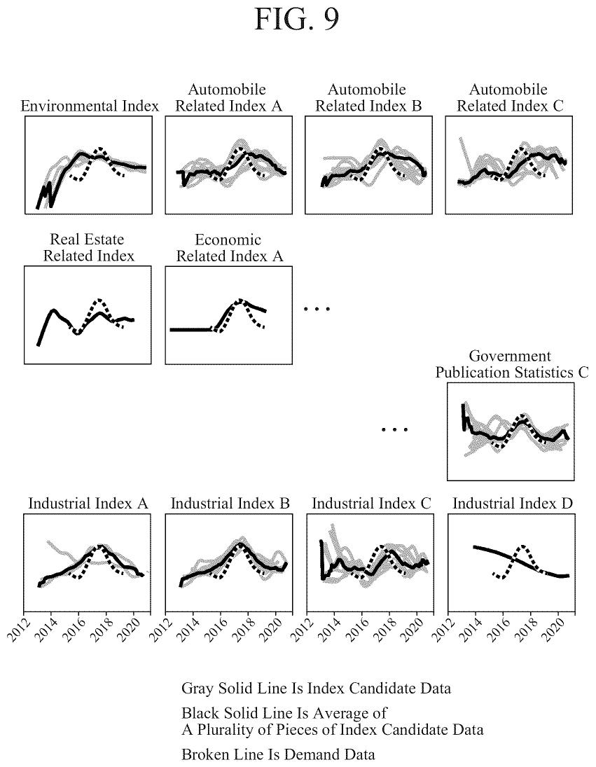

FIG. 9 is an explanatory diagram illustrating an example of index candidate data.

In FIG. 9, N=11 pieces of index candidate data are illustrated.

FIG. 9 illustrates, as an example of the index candidate data, index candidate data related to an environmental index, index candidate data related to an automobile related index A, index candidate data related to an automobile related index B, index candidate data related to an automobile related index C, index candidate data related to a real estate related index, and index candidate data related to an economic related index A.

In addition, FIG. 9 illustrates, as an example of the index candidate data, index candidate data related to government publication statistics C, index candidate data related to an industrial index A, index candidate data related to an industrial index B, index candidate data related to an industrial index C, and index candidate data related to an industrial index D.

In the figure, a gray solid line is index candidate data related to each index, and a black solid line is an average of a plurality of index candidate data indicated by the gray solid line. Further, a broken line is demand data of a product.

As the index candidate data Iₙ (n=1, . . . , N), for example, an average indicated by a black solid line is used.

The data acquiring unit 21 outputs each piece of the index candidate data I₁ to I_{N} and the demand data D to the data storing unit 22.

The data storing unit 22 stores each piece of the index candidate data I₁ to I_{N} and the demand data D.

The relevance degree calculating unit 23 acquires the index candidate data Iₙ (n=1, . . . , N) and the demand data D from the data storing unit 22.

The relevance degree calculating unit 23 calculates a relevance degree Cₙ (n=1, . . . , N) between the index indicated by the index candidate data Iₙ (n=1, . . . , N) and the demand indicated by the demand data D (step ST2 in FIG. 8).

The relevance degree calculating unit 23 outputs each of the index candidate data Iₙ (n=1, . . . , N), the demand data D, and the relevance degree Cₙ to the index data extracting unit 24.

The relevance degree calculating unit 23 also outputs the relevance degree Cₙ to the data storing unit 22.

Hereinafter, an example of calculation processing of the relevance degree Cₙ by the relevance degree calculating unit 23 will be specifically described.

First, the relevance degree calculating unit 23 calculates a standard deviation ISDₙ of the index candidate data Iₙ as a feature amount of the index candidate data Iₙ (n=1, . . . , N), and calculates a standard deviation DSD of the demand data D as a feature amount of the demand data D. Since the standard deviation calculation processing itself is a known technique, detailed description thereof will be omitted.

Next, the relevance degree calculating unit 23 calculates a covariance Cov between the index candidate data Iₙ and the demand data D. Since the covariance calculation processing itself is a known technique, detailed description thereof will be omitted.

The relevance degree calculating unit 23 calculates a correlation coefficient between the index candidate data Iₙ and the demand data D as the relevance degree Cₙ using the standard deviation ISDₙ of the index candidate data Iₙ, the standard deviation DSD of the demand data D, and the covariance Cov as expressed in the following formula (1).

$${C}_{n} = \frac{Cov}{{ISD}_{n} \times DSD} \qquad ( 1 )$$

Since the relevance degree Cₙ is a correlation coefficient, it is represented by a numerical value of −1 to +1. Therefore, the closer the relevance degree Cₙ is to +1, the stronger the positive correlation is, and the closer the relevance degree Cₙ is to −1, the stronger the negative correlation is. In addition, as the relevance degree Cₙ is closer to 0, the correlation is weaker.

Here, the relevance degree calculating unit 23 calculates a correlation coefficient between the index candidate data Iₙ and the demand data D as the relevance degree G. However, this is merely an example, and the relevance degree calculating unit 23 may calculate the distance between the index candidate data Iₙ and the demand data D as the relevance degree Cₙ.

The distance between the index candidate data Iₙ and the demand data D is represented by, for example, a Euclidean distance or a Manhattan distance. The distance between the index candidate data Iₙ and the demand data D is obtained by, for example, dynamic time warping (DTW). The calculation processing itself of the distance between the data by the DTW is a known technique, and thus a detailed description thereof will be omitted.

The index data extracting unit 24 acquires each of the index candidate data Iₙ (n=1, . . . , N), the demand data D, and the relevance degree Cₙ from the relevance degree calculating unit 23.

The index data extracting unit 24 extracts index data Iₘ′ (m=1, . . . , M) used for the demand prediction processing from among the N pieces of index candidate data I₁ to I_{N} on the basis of the relevance degree Cₙ (step ST3 in FIG. 8).

The index data extracting unit 24 outputs the demand data D to the prediction model selecting unit 26.

In addition, the index data extracting unit 24 outputs the index data Iₘ′ (m=1, . . . , M) to each of the demand prediction unit 27 and the data storing unit 22.

Hereinafter, an example of extraction processing of the index data Iₘ′ by the index data extracting unit 24 will be specifically described.

For example, in a case where the relevance degree Cₙ is a correlation coefficient and 0≤Cₙ≤1, the index data extracting unit 24 extracts the index candidate data Iₙ related to the relevance degree Cₙ as the index data Iₙ′ used for the demand prediction processing if |1−Cₙ| is equal to or less than a threshold Th₁. When |1−Cₙ| is larger than the threshold Th₁, the index data extracting unit 24 does not extract the index candidate data Iₙ related to the relevance degree Cₙ as the index data Iₘ′ used for the demand prediction processing.

For example, in a case where the relevance degree Cₙ is a correlation coefficient and −1≤Cₙ≤0, the index data extracting unit 24 extracts the index candidate data Iₙ related to the relevance degree Cₙ as the index data Iₘ′ used for the demand prediction processing if |1=Cₙ| is equal to or less than the threshold Th₁. When |1+Cₙ| is larger than the threshold Th₁, the index data extracting unit 24 does not extract the index candidate data Iₙ related to the relevance degree Cₙ as the index data Iₙ′ used for the demand prediction processing.

The threshold Th₁ is a value larger than 0 and smaller than 1. The threshold Th₁ may be stored in an internal memory of the index data extracting unit 24 or may be given from the outside of the demand prediction device 4 illustrated in FIG. 2.

Here, the index data extracting unit 24 extracts the index data used for the demand prediction processing on the basis of the comparison result between |1−Cₙ| or |1+Cₙ| and the threshold Th₁. However, this is merely an example, and the index data extracting unit 24 may extract the top M pieces of index candidate data Iₙ having a large absolute value of the relevance degree Cₙ as the index data Iₘ′ used for the demand prediction processing.

For example, in a case where the relevance degree Cₙ is a distance, if the relevance degree Cₙ is equal to or less than a threshold Th₂, the index data extracting unit 24 extracts the index candidate data Iₙ related to the relevance degree Cₙ as the index data Iₘ′ used for the demand prediction processing. When the relevance degree Cₙ is larger than the threshold Th₂, the index data extracting unit 24 does not extract the index candidate data Iₙ related to the relevance degree Cₙ as the index data used for the demand prediction processing.

Here, the index data extracting unit 24 extracts the index data Iₘ′ used for the demand prediction processing on the basis of the comparison result between the relevance degree Cₙ and the threshold value Th₂. However, this is merely an example, and the index data extracting unit 24 may extract the top M pieces of index candidate data Iₙ having a small absolute value of the relevance degree Cₙ as the index data Iₘ′ used for the demand prediction processing.

The prediction model selecting unit 26 acquires the demand data D from the index data extracting unit 24.

Based on the demand data D, the prediction model selecting unit 26 selects a prediction model PM to which the index data Iₘ′ is given from among the G prediction models PM₁ to PM_{G} stored in the prediction model storing unit 25 (step ST4 in FIG. 8).

Hereinafter, an example of selection processing of the prediction model PM by the prediction model selecting unit 26 will be specifically described.

The prediction model selecting unit 26 calculates a fluctuation range F of the demand data D. The fluctuation range F of the demand data D is an absolute value of a difference between the minimum value of the demand data D and the maximum value of the demand data D.

In addition, the prediction model selecting unit 26 calculates a fluctuation range F_{g} of a demand prediction result R_{g} output from the prediction model PM_{g} (g=1, . . . , G). The fluctuation range F_{g} of the prediction result R_{g} is an absolute value of a difference between the minimum value of the prediction result R_{g} and the maximum value of the prediction result R_{g}. The minimum value of the prediction result R_{g} and the maximum value of the prediction result R_{g} are obtained from the prediction model PM_{g}.

The prediction model selecting unit 26 searches for the fluctuation range F_{g} of the prediction result R_{g} closest to the fluctuation range F of the demand data D among fluctuation ranges F₁ to F_{G} of G prediction results R₁ to R_{G}.

The prediction model selecting unit 26 selects the prediction model PM_{g} related to the fluctuation range F_{g} obtained by the searching as the prediction model PM to which the index data Iₘ′ is given from among the G prediction models PM₁ to PM_{G}.

The demand prediction unit 27 acquires the index data Iₘ′ (m=1, . . . , M) from the index data extracting unit 24.

The demand prediction unit 27 performs demand prediction processing using the index data Iₘ′ (m=1, . . . , M) (step ST5 in FIG. 8).

That is, the demand prediction unit 27 gives the index data I₁′ to I_{M}′ to the prediction model PM selected by the prediction model selecting unit 26, and performs demand prediction processing of acquiring the prediction result R of the future demand of the product from the prediction model PM.

Since the demand prediction unit 27 performs the demand prediction processing using the index data Iₘ′ indicating an index having a high relevance degree with the past demand indicated by the demand data D, it is possible to obtain a highly accurate prediction result R.

On the other hand, since the demand prediction unit 27 does not use the index candidate data indicating the index having a low relevance with the past demand indicated by the demand data D for the demand prediction processing, even if the index candidate data Iₙ indicating the index having a low relevance degree with the past demand indicated by the demand data D is given to the data acquiring unit 21, it is possible to prevent a decrease in prediction accuracy of the demand.

The demand prediction unit 27 outputs the prediction result R of the demand to the display data output unit 28.

Here, the demand prediction unit 27 gives the index data I₁′ to I_{M}′ to the prediction model PM and acquires the prediction result R of the demand from the prediction model PM. However, this is merely an example, and the demand prediction unit 27 may obtain the prediction result R of the demand by performing regression analysis on the index data I₁′ to I_{M}′. Since the regression analysis processing itself of the index data I₁′ to I_{M}′ is a known technique, detailed description thereof will be omitted.

The display data output unit 28 acquires the prediction result R of the demand from the demand prediction unit 27.

The display data output unit 28 generates display data H for displaying the prediction result R of the demand, and outputs the display data H to the display unit 12.

The analysis result output unit 11 of the decision making support device 2 acquires, from the data storing unit 22, the demand data D acquired by the data acquiring unit 21 and the index data Iₘ′ (m=1, . . . , M) extracted by the index data extracting unit 24 and used for the demand prediction processing.

The analysis result output unit 11 outputs each of the index data Iₘ′ (m=1, . . . , M) and the demand data D to the display unit 12.

The display unit 12 displays the prediction result R of the demand on the display according to the display data H output from the display data output unit 28.

In addition, the display unit 12 displays each of the index data I₁′ to I_{M}′ and the demand data D on the display.

Next, the operation of the learning device 3 illustrated in FIG. 5 will be described.

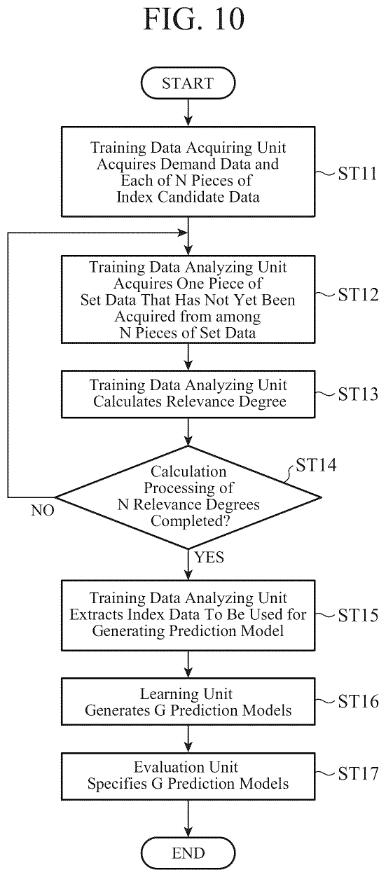

FIG. 10 is a flowchart illustrating a processing procedure of the learning device 3.

The training data acquiring unit 51 acquires the demand data D from the data storing unit 22.

In addition, the training data acquiring unit 51 acquires N pieces of index candidate data I₁ to I_{N} from the data storing unit 22 (step ST11 in FIG. 10).

The training data acquiring unit 51 sequentially extracts one piece of index candidate data Iₙ from among the N pieces of index candidate data I₁ to I_{N}, prepares N pieces of set data including one piece of index candidate data Iₙ and demand data D, and outputs the N pieces of set data to the training data storing unit 52.

Each of the index candidate data Iₙ and the demand data D included in each set data is past data than each of the index candidate data Iₙ and the demand data D given to the demand prediction device 4 when the demand prediction processing is performed by the demand prediction device 4. The demand data D included in each set data is a future data ahead of the index candidate data Iₙ included in the set data.

The training data storing unit 52 stores each of the N pieces of set data output from the training data acquiring unit 51.

The training data analyzing unit 53 acquires one piece of set data that has not yet been acquired from among the N pieces of set data included in the training data storing unit 52 (step ST12 in FIG. 10).

The training data analyzing unit 53 calculates a relevance degree Cₙ between the index indicated by one piece of index candidate data Iₙ and the demand indicated by the demand data D included in the acquired set data (step ST13 in FIG. 10).

As the calculation processing of the relevance degree Cₙ by the training data analyzing unit 53, for example, a method similar to the calculation processing of the relevance degree Cₙ by the relevance degree calculating unit 23 illustrated in FIG. 2 can be used.

Since the N pieces of set data have not been acquired yet, if the calculation processing of the N relevance degrees C₁ to C_{N} has not been completed (in the case of step ST14: NO in FIG. 10), the training data analyzing unit 53 repeatedly performs the processing of steps ST12 to ST13.

If the calculation processing of the N relevance degrees C₁ to C_{N} is completed (step ST14 in FIG. 10: YES), the training data analyzing unit 53 extracts index data Iⱼ″ (j=1, . . . , J) to be used for generating a prediction model from among the N pieces of index candidate data Iᵢ to I_{N} on the basis of the relevance degree Cₙ (n=1, . . . , N) (step ST15 in FIG. 10).

As the extraction processing of the index data Iⱼ″ by the training data analyzing unit 53, for example, a method similar to the extraction processing of the index data Iₘ″ by the index data extracting unit 24 illustrated in FIG. 2 can be used.

The training data analyzing unit 53 outputs the extracted index data Iⱼ″ (j=1, . . . , J) and the demand data D included in the acquired set data to the learning unit 54.

The learning unit 54 acquires each of the index data Iⱼ″ (j=1, . . . , J) and the demand data D from the training data analyzing unit 53.

The learning unit 54 generates Q prediction models using each of the index data Iⱼ″ (j=1, . . . , J) and the demand data D (step ST16 in FIG. 10).

Hereinafter, an example of prediction model generation processing by the learning unit 54 will be specifically described.

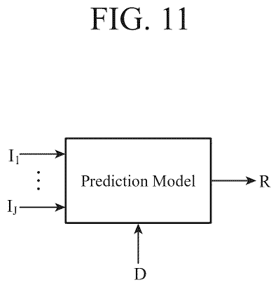

FIG. 11 is an explanatory diagram illustrating an input and output relationship of one prediction model.

The learning unit 54 gives the index data Iⱼ″ (j=1, . . . , J) as the explanatory variable to each of the Q prediction models different from each other in the algorithm, and gives the demand data D as the objective variable which is the teacher data to each prediction model.

The learning unit 54 causes each prediction model to perform learning processing so that data corresponding to the demand data D is output as the prediction result R from each prediction model. The learning processing is processing of adjusting a weight or the like that is a coefficient for each explanatory variable so that data corresponding to the demand data D is output as the prediction result R.

The learning unit 54 outputs the learned Q prediction models to the evaluation unit 55.

The evaluation unit 55 acquires the Q prediction models from the learning unit 54.

The evaluation unit 55 evaluates each of the Q prediction models, and specifies the top G prediction models PM₁ to PM_{G} having relatively high evaluation among the Q prediction models (step ST17 in FIG. 10).

The evaluation unit 55 outputs the G prediction models PM₁ to PM_{G} to the prediction model storing unit 25.

Hereinafter, an example of specification processing of the G prediction models PM₁ to PM_{G} by the evaluation unit 55 will be specifically described.

The evaluation unit 55 calculates a fluctuation range F of the demand data D. The fluctuation range F of the demand data D is an absolute value of a difference between the minimum value of the demand data D and the maximum value of the demand data D.

In addition, the evaluation unit 55 calculates a fluctuation range of the prediction result of the demand output from each of the Q prediction models. The fluctuation range of the prediction result is an absolute value of a difference between the minimum value of the prediction result and the maximum value of the prediction result. The minimum value of the prediction result and the maximum value of the prediction result are obtained from each of the prediction models.

The evaluation unit 55 searches for the fluctuation ranges of the top G prediction results close to the fluctuation range F of the demand data D in the fluctuation range of the Q prediction results.

The evaluation unit 55 specifies prediction models related to the fluctuation range of the top G prediction results as the G prediction models PM₁ to PM_{G} from among the Q prediction models.

In the first embodiment described above, the demand prediction device 4 is configured to include the data acquiring unit 21 to acquire demand data indicating a temporal change of a past demand in a product of a demand prediction target and index candidate data indicating each of a plurality of indexes which are candidates of an index related to the past demand; the relevance degree calculating unit 23 to calculate a relevance degree between an index indicated by each of index candidate data acquired by the data acquiring unit 21 and a demand indicated by the demand data acquired by the data acquiring unit 21; the index data extracting unit 24 to extract index data to be used for demand prediction processing for predicting a future demand of the product from among a plurality of index candidate data acquired by the data acquiring unit 21 on the basis of the relevance degree calculated by the relevance degree calculating unit 23; and the demand prediction unit 27 to perform the demand prediction processing using the index data extracted by the index data extracting unit 24. Therefore, the demand prediction device 4 can prevent the prediction result of the demand from deviating from the future demand of the product even if the index candidate data indicating the index having a low relevance degree with the demand of the product is included in the plurality of given index candidate data.

In the demand prediction device 4 illustrated in FIG. 2, the analysis result output unit 11 outputs each piece of the index data Iₘ′ (m=1, . . . , M) and the demand data Iₘ′ to the display unit 12, and the display unit 12 displays each piece of the index data and the demand data D on the display. However, this is merely an example, and the relevance degree calculating unit 23 outputs a relevance degree Cm between the index indicated by the index data Iₘ′ (m=1, . . . , M) and the demand indicated by the demand data D to the analysis result output unit 11 via the data storing unit 22. Then, the analysis result output unit 11 may output each of the index data Iₘ′, the demand data D, and the relevance degree Cₘ to the display unit 12, and the display unit 12 may display each of the index data Iₘ′ the demand data D, and the relevance degree Cₘ on the display.

In the demand prediction device 4 illustrated in FIG. 2, the data acquiring unit 21 acquires each of the index candidate data Iₙ (n=1, . . . , N) and the demand data D. However, this is merely an example, and the data acquiring unit 21 may acquire related data in addition to the index candidate data Iₙ and the demand data D. Examples of the related data include calendar information indicating weekdays, holidays, and the like, sales promotion information indicating details of product sales promotion, manufacturing information indicating a manufacturing status of a product, and distribution information indicating a distribution status of a product.

When the related data is acquired by the data acquiring unit 21, the learning unit 54 may generate Q prediction models using each of the index data Iⱼ″ (j=1, . . . , J), the demand data D, and the related data. For example, the learning unit 54 gives each of the index data Iⱼ″ (j=1, . . . , J) and the related data as explanatory variables to each of the Q prediction models different from each other in the algorithm, and gives the demand data D as an objective variable to each of the prediction models. Then, the learning unit 54 causes each prediction model to perform learning processing so that data corresponding to the demand data D is output as the prediction result R from each prediction model.

In the demand prediction device 4 illustrated in FIG. 2, the index data extracting unit 24 extracts, for example, top M pieces of index candidate data Iₙ having a large absolute value of the relevance degree Cₙ from among the N pieces of index candidate data I₁ to I_{N} as index data Iₘ′ used for the demand prediction processing. However, this is merely an example, and the index data extracting unit 24 may extract index data to be used for the demand prediction processing from among pieces of index candidate data indicating each of a plurality of economic indexes on the basis of the relevance degree Cₙ, and extract index data to be used for the demand prediction processing from among pieces of index candidate data indicating each of a plurality of indexes other than the economic indexes. Examples of the index other than the economic index include a statistical index and weather information.

It is assumed that N pieces of index candidate data I₁ to I_{N} include, for example, index candidate data indicating each of a plurality of economic indexes, index candidate data indicating each of a plurality of statistical indexes, and index candidate data indicating each of a plurality of pieces of weather information. In this case, on the basis of the relevance degree Cₙ, the index data extracting unit 24 extracts, as index data to be used for the demand prediction processing, index candidate data having the highest relevance degree among the pieces of index candidate data indicating each of the plurality of economic indexes. In addition, on the basis of the relevance degree Cₙ, the index data extracting unit 24 extracts index candidate data having the highest relevance degree among the pieces of index candidate data indicating each of the plurality of statistical indexes as index data used for the demand prediction processing. Further, on the basis of the relevance degree Cₙ, the index data extracting unit 24 extracts index candidate data having the highest relevance degree among the pieces of index candidate data indicating each of the plurality of pieces of weather information as index data used for the demand prediction processing.

The demand prediction device 4 illustrated in FIG. 2 includes the data storing unit 22 and the prediction model storing unit 25. However, this is merely an example, and the data storing unit 22 and the prediction model storing unit 25 may be provided in a storage device on a network. In this case, the relevance degree calculating unit 23 and the index data extracting unit 24 have a communication function for accessing the data storing unit 22, and the prediction model selecting unit 26 has a communication function for accessing the prediction model storing unit 25.

### Second Embodiment

In a second embodiment, a demand prediction device 4 including a data acquiring unit 81 to acquire setting data indicating semantic similarity between an index indicated by index candidate data Iₙ (n=1, . . . , N) and a demand indicated by demand data D in addition to index candidate data I₁ to I_{N} and demand data D will be described.

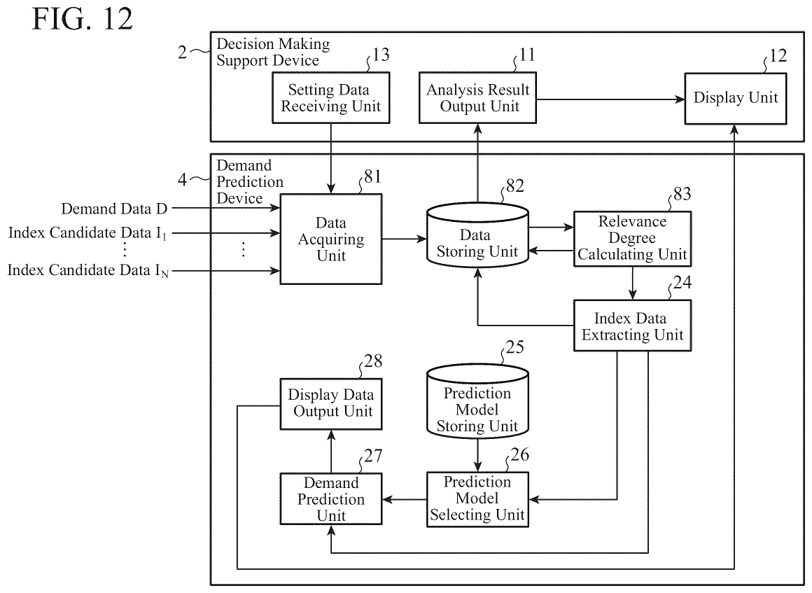

FIG. 12 is a configuration diagram illustrating a decision making support device 2 and a demand prediction device 4 according to the second embodiment. In FIG. 12, the same reference numerals as those in FIG. 2 denote the same or corresponding parts, and thus description thereof is omitted.

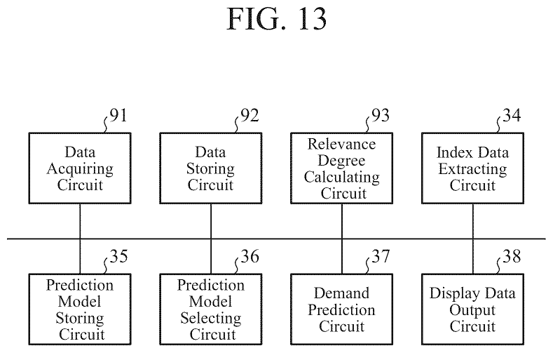

FIG. 13 is a hardware configuration diagram illustrating hardware of the demand prediction device 4 according to the second embodiment. In FIG. 13, the same reference numerals as those in FIG. 3 denote the same or corresponding parts, and thus description thereof is omitted.

The decision making support device 2 includes an analysis result output unit 11, a display unit 12, and a setting data receiving unit 13.

The setting data receiving unit 13 includes a man-machine interface such as a keyboard, a mouse, or a touch panel.

The setting data receiving unit 13 performs reception processing of setting data B indicating a semantic similarity Cₙ′ between the index indicated by the index candidate data Iₙ (n=1, . . ., N) and the demand indicated by the demand data D, and outputs the setting data B to the data acquiring unit 81 of the demand prediction device 4. That is, when a user operates the setting data receiving unit 13, the setting data receiving unit 13 performs reception processing of the setting data B and outputs the setting data B to the data acquiring unit 81 of the demand prediction device 4. The semantic similarity G′ indicates a similarity degree between the index and the demand, set by the user.

The demand prediction device 4 includes a data acquiring unit 81, a data storing unit 82, a relevance degree calculating unit 83, an index data extracting unit 24, a prediction model storing unit 25, a prediction model selecting unit 26, a demand prediction unit 27, and a display data output unit 28.

The data acquiring unit 81 is implemented by, for example, a data acquiring circuit 91 illustrated in FIG. 13.

The data acquiring unit 81 acquires the index candidate data I₁ to I_{N} and the demand data D similarly to the data acquiring unit 21 illustrated in FIG. 2.

In addition, the data acquiring unit 81 acquires the setting data B output from the setting data receiving unit 13.

The data acquiring unit 81 outputs each piece of the index candidate data I₁ to I_{N}, the demand data D, and the setting data B to the data storing unit 82.

The data storing unit 82 is implemented by, for example, a data storing circuit 92 illustrated in FIG. 13.

The data storing unit 82 stores each piece of the index candidate data I₁ to I_{N}, the demand data D, and the setting data B output from the data acquiring unit 81.

The relevance degree calculating unit 83 is implemented by, for example, a relevance degree calculating circuit 93 illustrated in FIG. 13.

The relevance degree calculating unit 83 acquires the index candidate data I₁ to I_{N} and the demand data D from the data storing unit 82 similarly to the relevance degree calculating unit 23 illustrated in FIG. 2.

The relevance degree calculating unit 83 also acquires the setting data B from the data storing unit 82.

Instead of calculating the relevance degree Cₙ (n=1, . . . , N) between the index indicated by the index candidate data Iₙ (n=1, . . . , N) and the demand indicated by the demand data D, the relevance degree calculating unit 83 outputs the semantic similarity Cₙ′ indicated by the setting data B to the index data extracting unit 24 as the relevance degree Cₙ.

In FIG. 12, it is assumed that each of the data acquiring unit 81, the data storing unit 82, the relevance degree calculating unit 83, the index data extracting unit 24, the prediction model storing unit 25, the prediction model selecting unit 26, the demand prediction unit 27, and the display data output unit 28, which are components of the demand prediction device 4, is implemented by dedicated hardware as illustrated in FIG. 13. That is, it is assumed that the demand prediction device 4 is implemented by the data acquiring circuit 91, the data storing circuit 92, the relevance degree calculating circuit 93, the index data extracting circuit 34, the prediction model storing circuit 35, the prediction model selecting circuit 36, the demand prediction circuit 37, and the display data output circuit 38.

Here, each of the data storing circuit 92 and the prediction model storing circuit 35 corresponds to, for example, a nonvolatile or volatile semiconductor memory such as RAM, ROM, a flash memory, EPROM, or EEPROM, a magnetic disk, a flexible disk, an optical disk, a compact disk, a mini disk, or DVD.

In addition, each of the data acquiring circuit 91, the relevance degree calculating circuit 93, the index data extracting circuit 34, the prediction model selecting circuit 36, the demand prediction circuit 37, and the display data output circuit 38 corresponds to, for example, a single circuit, a composite circuit, a programmed processor, a parallel-programmed processor, ASIC, FPGA, or a combination thereof.

The components of the demand prediction device 4 are not limited to those implemented by dedicated hardware, and the demand prediction device 4 may be implemented by software, firmware, or a combination of software and firmware.

In a case where the demand prediction device 4 is implemented by software, firmware, or the like, the data storing unit 82 and the prediction model storing unit 25 are configured on the memory 41 of the computer illustrated in FIG. 4. A program for causing a computer to execute each processing procedure in the data acquiring unit 81, the relevance degree calculating unit 83, the index data extracting unit 24, the prediction model selecting unit 26, the demand prediction unit 27, and the display data output unit 28 is stored in the memory 41. Then, the processor 42 of the computer executes the program stored in the memory 41.

In addition, FIG. 13 illustrates an example in which each of the components of the demand prediction device 4 is implemented by dedicated hardware, and FIG. 4 illustrates an example in which the demand prediction device 4 is implemented by software, firmware, or the like. However, this is merely an example, and some components in the demand prediction device 4 may be implemented by dedicated hardware, and the remaining components may be implemented by software, firmware, or the like.

Next, the operation of the demand prediction device 4 illustrated in FIG. 12 will be described.

Since operations of the components other than the data acquiring unit 81, the data storing unit 82, and the relevance degree calculating unit 83 are similar to those of the demand prediction device 4 illustrated in FIG. 2, the operations of the data acquiring unit 81, the data storing unit 82, and the relevance degree calculating unit 83 will be mainly described here.

The setting data receiving unit 13 of the decision making support device 2 performs reception processing of the setting data B indicating the semantic similarity Cₙ′ between the index indicated by the index candidate data Iₙ (n=1, . . . , N) and the demand indicated by the demand data D.

The setting data receiving unit 13 outputs the setting data B to the data acquiring unit 81 of the demand prediction device 4.

As an aspect in which the semantic similarity Cₙ′ between the index indicated by the index candidate data Iₙ and the demand indicated by the demand data D is high, there are aspects as shown in (1) to (2) below.

(1) When the product related to the demand data D is included in the product related to the index candidate data Iₙ or when the product related to the index candidate data Iₙ is included in the product related to the demand data D, the semantic similarity Cₙ′ between the index indicated by the index candidate data Iₙ and the demand indicated by the demand data D increases.

For example, when the product related to the demand data D is a control device mounted on an elevator and the product related to the index candidate data Iₙ is an elevator, or when the product related to the demand data D is an elevator and the product related to the index candidate data Iₙ is a control device mounted on an elevator, the semantic similarity Cₙ′ between the index indicated by the index candidate data Iₙ and the demand indicated by the demand data D increases.

(2) When there is a physical relationship between the product related to the demand data D and the product related to the index candidate data Iₙ, the semantic similarity Cₙ′ between the index indicated by the index candidate data Iₙ and the demand indicated by the demand data D increases.

For example, when the product related to the demand data D is a voltmeter and the product related to the index candidate data Iₙ is an electric power meter, the semantic similarity Cₙ′ between the index indicated by the index candidate data Iₙ and the demand indicated by the demand data D increases.

The aspects shown in (1) to (2) are merely examples, and the aspect in which the similarity Cₙ′ is high may be aspects other than (1) to (2).

Here, for simplicity of explanation, it is assumed that the semantic similarity Cₙ′ between the index indicated by the index candidate data Iₙ and the demand indicated by the demand data D is low except for the aspects illustrated in (1) to (2).

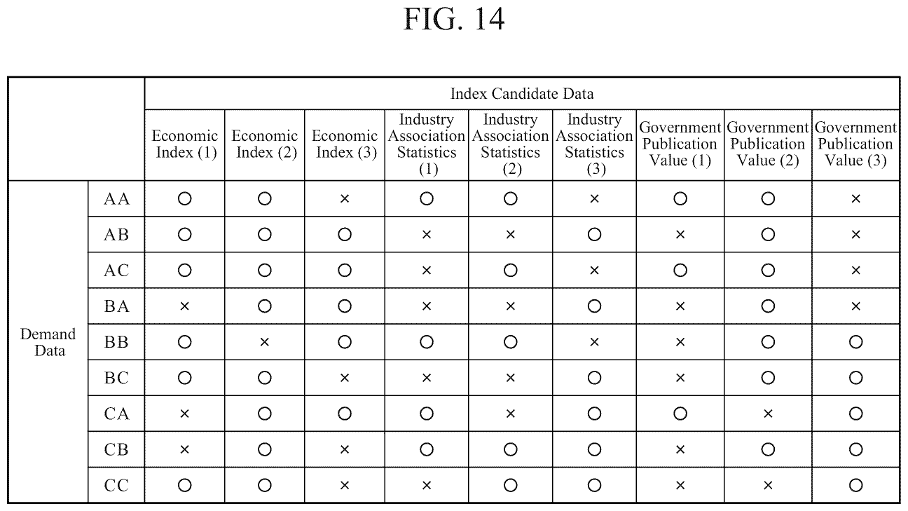

FIG. 14 is an explanatory diagram illustrating an example of the setting data B.

In the example of FIG. 14, nine pieces of demand data D are illustrated. In FIG. 14, nine pieces of demand data D are distinguished as demand data (AA), demand data (AB), demand data (AC), demand data (BA), demand data (BB), demand data (BC), demand data (CA), demand data (CB), and demand data (CC).

In the example of FIG. 14, nine pieces of index candidate data Iₙ (n=1, . . . , 9) are illustrated. In the example of FIG. 14, the index candidate data I₁ is index candidate data related to an economic index (1), the index candidate data I₂ is index candidate data related to an economic index (2), and the index candidate data I₃ is index candidate data related to an economic index (3).

The index candidate data I₄ is index candidate data related to industry association statistics (1), the index candidate data I₅ is index candidate data related to industry association statistics (2), and the index candidate data I₆ is index candidate data related to industry association statistics (3).

The index candidate data I₇ is index candidate data related to a government publication value (1), the index candidate data I₈ is index candidate data related to a government publication value (2), and the index candidate data I₉ is index candidate data related to a government publication value (3).

In FIG. 14, ∘ indicates that the semantic similarity between the index indicated by the index candidate data and the demand indicated by the demand data is equal to or more than a threshold Th₃. Therefore, for example, the setting data B indicating the semantic similarity C_{1-AA}′ between the index indicated by the index candidate data I₁ related to the economic index (1) and the demand indicated by the demand data (AA) is set to be equal to or more than the threshold Th₃.

× indicates that the semantic similarity between the index indicated by the index candidate data and the demand indicated by the demand data is lower than the threshold Th₃. Therefore, for example, the setting data B indicating the semantic similarity C_{7-BA}′ between the index indicated by the index candidate data I₇ related to the government publication value (1) and the demand indicated by the demand data (BA) is set to be less than the threshold Th₃.

In the example of FIG. 14, the setting data B indicating similarity is set for each of index candidate data. However, this is merely an example, and the setting data B indicating the similarity may be set for each group including one or more pieces of index candidate data. Furthermore, the similarity may be a discrete value indicating either ∘ or ×, a discrete value indicating a binary value or a ternary value, or a continuous value between 0 and 1.

The data acquiring unit 81 acquires the index candidate data I₁ to I_{N} and the demand data D similarly to the data acquiring unit 21 illustrated in FIG. 2.

In addition, the data acquiring unit 81 acquires the setting data B from the setting data receiving unit 13.

The data acquiring unit 81 outputs each piece of the index candidate data I₁ to I_{N}, the demand data D, and the setting data B to the data storing unit 82.

The data storing unit 82 stores each piece of the index candidate data I₁ to I_{N}, the demand data D, and the setting data B.

The relevance degree calculating unit 83 acquires each piece of the index candidate data I₁ to I_{N}, the demand data D, and the setting data B from the data storing unit 82.

Instead of calculating the relevance degree Cₙ (n=1, . . . , N) between the index indicated by the index candidate data Iₙ (n=1, . . . , N) and the demand indicated by the demand data D, the relevance degree calculating unit 83 outputs the semantic similarity Cₙ′ indicated by the setting data B to the index data extracting unit 24 as the relevance degree Cₙ.

In addition, the relevance degree calculating unit 83 outputs each piece of the index candidate data Iₙ and the demand data D to the index data extracting unit 24.

The semantic similarity Cₙ′ indicated by the setting data B corresponds to a correlation coefficient between the index candidate data Iₙ and the demand data D or a distance between the index candidate data Iₙ and the demand data D.

In the second embodiment described above, in addition to the plurality of index candidate data and demand data, the data acquiring unit 81 acquires setting data indicating semantic similarity between the index indicated by each piece of index candidate data and the demand indicated by the demand data. In addition, the demand prediction device 4 illustrated in FIG. 12 is configured so that the relevance degree calculating unit 83 outputs the semantic similarity indicated by the setting data to the index data extracting unit 24 as the relevance degree instead of calculating the relevance degree between the index indicated by each piece of index candidate data acquired by the data acquiring unit 81 and the demand indicated by the demand data acquired by the data acquiring unit 81. Therefore, similarly to the demand prediction device 4 illustrated in FIG. 2, the demand prediction device 4 illustrated in FIG. 12 can prevent the prediction result of the demand from deviating from the future demand of the product even if the index candidate data indicating the index having the low relevance degree with the demand of the product is included in the plurality of given index candidate data.

In the learning device 3 illustrated in FIG. 5, the training data analyzing unit 53 calculates the relevance degree Cₙ between the index indicated by the index candidate data Iₙ (n=1, . . . , N) and the demand indicated by the demand data D, and extracts index data Iⱼ″ (j=1, . . . , J) used for generating the prediction model from among the N pieces of index candidate data I₁ to I_{N} on the basis of the relevance degree Cₙ. However, this is merely an example, and the training data analyzing unit 53 may set the similarity Cₙ′ indicated by the setting data B as the relevance degree Cₙ, and extract the index data Iⱼ″ to be used for generating the prediction model from among the N pieces of index candidate data I₁ to I_{N} on the basis of the relevance degree Cₙ.

### Third Embodiment

In a third embodiment, a demand prediction device 4 in which a relevance degree calculating unit 84 calculates a relevance degree Cₙ between the index indicated by the index candidate data Iₙ and the demand indicated by the demand data D from the correlation coefficient between the index candidate data Iₙ (n=1, . . . , N) and the demand data D or the distance between the index candidate data Iₙ and the demand data D, and the semantic similarity Cₙ′ indicated by the setting data B will be described.

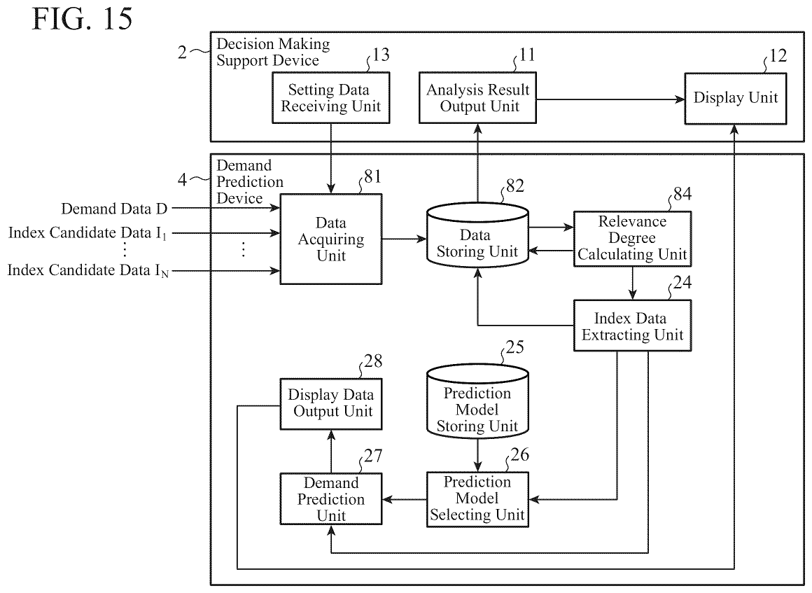

FIG. 15 is a configuration diagram illustrating a decision making support device 2 and a demand prediction device 4 according to the third embodiment. In FIG. 15, the same reference numerals as those in FIGS. 2 and 12 denote the same or corresponding parts, and thus description thereof is omitted.

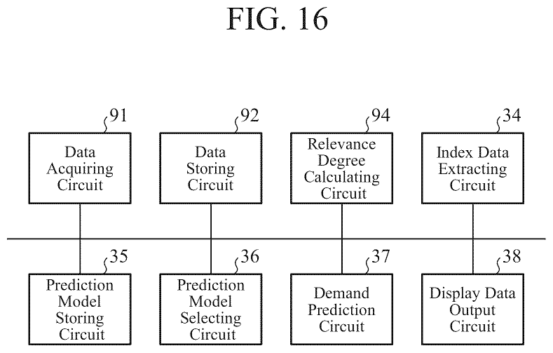

FIG. 16 is a hardware configuration diagram illustrating hardware of the demand prediction device 4 according to the third embodiment. In FIG. 16, the same reference numerals as those in FIGS. 3 and 13 denote the same or corresponding parts, and thus description thereof is omitted.

The demand prediction device 4 includes a data acquiring unit 81, a data storing unit 82, the relevance degree calculating unit 84, an index data extracting unit 24, a prediction model storing unit 25, a prediction model selecting unit 26, a demand prediction unit 27, and a display data output unit 28.

The relevance degree calculating unit 84 is implemented by, for example, a relevance degree calculating circuit 94 illustrated in FIG. 16.

Similarly to the relevance degree calculating unit 83 illustrated in FIG. 12, the relevance degree calculating unit 84 acquires each of the index candidate data I₁ to I_{N}, the demand data D, and the setting data B from the data storing unit 82.

Similarly to the relevance degree calculating unit 23 illustrated in FIG. 2, the relevance degree calculating unit 84 calculates a correlation coefficient between the index candidate data Iₙ (n=1, . . . , N) and the demand data D or a distance between the index candidate data Iₙ and the demand data D.

The relevance degree calculating unit 84 calculates the relevance degree Cₙ between the index indicated by the index candidate data Iₙ and the demand indicated by the demand data D from the correlation coefficient or the distance and the semantic similarity Cₙ′ indicated by the setting data B.

In FIG. 15, it is assumed that each of the data acquiring unit 81, the data storing unit 82, the relevance degree calculating unit 84, the index data extracting unit 24, the prediction model storing unit 25, the prediction model selecting unit 26, the demand prediction unit 27, and the display data output unit 28, which are components of the demand prediction device 4, is implemented by dedicated hardware as illustrated in FIG. 16. That is, it is assumed that the demand prediction device 4 is implemented by the data acquiring circuit 91, the data storing circuit 92, the relevance degree calculating circuit 94, the index data extracting circuit 34, the prediction model storing circuit 35, the prediction model selecting circuit 36, the demand prediction circuit 37, and the display data output circuit 38.

Each of the data acquiring circuit 91, the relevance degree calculating circuit 94, the index data extracting circuit 34, the prediction model selecting circuit 36, the demand prediction circuit 37, and the display data output circuit 38 corresponds to, for example, a single circuit, a composite circuit, a programmed processor, a parallel-programmed processor, ASIC, FPGA, or a combination thereof.

The components of the demand prediction device 4 are not limited to those implemented by dedicated hardware, and the demand prediction device 4 may be implemented by software, firmware, or a combination of software and firmware.

In a case where the demand prediction device 4 is implemented by software, firmware, or the like, the data storing unit 82 and the prediction model storing unit 25 are configured on the memory 41 of the computer illustrated in FIG. 4. A program for causing a computer to execute each processing procedure in the data acquiring unit 81, the relevance degree calculating unit 84, the index data extracting unit 24, the prediction model selecting unit 26, the demand prediction unit 27, and the display data output unit 28 is stored in the memory 41. Then, the processor 42 of the computer executes the program stored in the memory 41.

In addition, FIG. 16 illustrates an example in which each of the components of the demand prediction device 4 is implemented by dedicated hardware, and FIG. 4 illustrates an example in which the demand prediction device 4 is implemented by software, firmware, or the like. However, this is merely an example, and some components in the demand prediction device 4 may be implemented by dedicated hardware, and the remaining components may be implemented by software, firmware, or the like.

Next, the operation of the demand prediction device 4 illustrated in FIG. 15 will be described.

Since the operations of the components other than the relevance degree calculating unit 84 are similar to those of the demand prediction device 4 illustrated in FIG. 12, only the operation of the relevance degree calculating unit 84 will be described here.

Similarly to the relevance degree calculating unit 83 illustrated in FIG. 12, the relevance degree calculating unit 84 acquires each of the index candidate data I₁ to I_{N}, the demand data D, and the setting data B from the data storing unit 82.

Similarly to the relevance degree calculating unit 23 illustrated in FIG. 2, the relevance degree calculating unit 84 calculates a correlation coefficient ccₙ between the index candidate data Iₙ (n=1, . . . , N) and the demand data D or a distance Iₙ between the index candidate data Iₙ and the demand data D.

The relevance degree calculating unit 84 calculates the relevance degree Cₙ between the index indicated by the index candidate data Iₙ and the demand indicated by the demand data D from the correlation coefficient ccₙ and the semantic similarity Cₙ′ indicated by the setting data B as expressed in the following formula (2).

Alternatively, the relevance degree calculating unit 84 calculates the relevance degree Cₙ between the index indicated by the index candidate data Iₙ and the demand indicated by the demand data D from the distance Lₙ and the semantic similarity Cₙ′ indicated by the setting data B as expressed in the following formula (3).

$${C}_{n} = \frac{{cc}_{n} + {C}_{n}^{′}}{2} \qquad ( 2 )$$

$${C}_{n} = \frac{{L}_{n} + {C}_{n}^{′}}{2} \qquad ( 3 )$$

The relevance degree calculating unit 84 outputs each of the index candidate data Iₙ (n=1, . . . , N), the demand data D, and the relevance degree Cₙ to the index data extracting unit 24.

Here, the relevance degree calculating unit 84 calculates an average of the correlation coefficient ccₙ or the distance Lₙ and the semantic similarity Cₙ′ indicated by the setting data B as the relevance degree Cₙ. However, this is merely an example, and the relevance degree calculating unit 84 may score the correlation coefficient ccₙ or the distance Lₙ and the similarity Cₙ′ and calculate the relevance degree Cₙ on the basis of the score as described below.

In a case where the correlation coefficient ccₙ is used among the correlation coefficient ccₙ and the distance Lₙ, the relevance degree calculating unit 84 sorts the N correlation coefficients cc₁ to cc_{N} in descending order of absolute value, and sets a larger score Sccₙ for the correlation coefficient ccₙ with an earlier position.

In a case where the distance Lₙ is used among the correlation coefficient ccₙ and the distance Lₙ, the relevance degree calculating unit 84 sorts the N distances L₁ to L_{N} in ascending order of absolute values, and sets a larger score SLₙ for the distance Lₙ with an earlier position.

The relevance degree calculating unit 84 sorts the N similarities C₁′ to C_{N}′ in descending order of absolute values, and sets a larger score SC′ₙ for the similarity Cₙ′ with an earlier position.

As expressed in the following formula (4) or (5), the relevance degree calculating unit 84 calculates, as the relevance degree Cₙ, a total value of the score Sccₙ of the correlation coefficient ccₙ or the score SLₙ of the distance Lₙ and the score SC′ₙ of the similarity Cₙ′.

Cₙ=Sccₙ+Sc′ₙ (4)

Cₙ=SLₙ+Sc′ₙ_{ₙ} (5)

In the third embodiment, the demand prediction device 4 illustrated in FIG. 15 is configured so that the data acquiring unit 81 acquires setting data indicating the semantic similarity between the index indicated by each piece of index candidate data and the demand indicated by the demand data in addition to the plurality of index candidate data and the demand data, the relevance degree calculating unit 84 calculates the correlation coefficient between each piece of index candidate data and the demand data or the distance between each piece of index candidate data and the demand data, and calculates the relevance degree between the index indicated by each piece of index candidate data and the demand indicated by the demand data from each of correlation coefficients or each of distances and the semantic similarity indicated by the setting data. Therefore, the demand prediction device 4 illustrated in FIG. 15 can improve the prediction accuracy of the demand more than the demand prediction device 4 illustrated in FIG. 2 or the demand prediction device 4 illustrated in FIG. 12.

Note that, in the present disclosure, it is possible to freely combine each embodiment, to modify any components of each embodiment, or to omit any components in each embodiment.

### INDUSTRIAL APPLICABILITY

The present disclosure is suitable for a demand prediction device and a demand prediction method.

### REFERENCE SIGNS LIST

1: demand prediction system, 2: decision making support device, 3: learning device, 4: demand prediction device, 11: analysis result output unit, 12: display unit, 13: setting data receiving unit, 21: data acquiring unit, 22: data storing unit, 23: relevance degree calculating unit, 24: index data extracting unit, 25: prediction model storing unit, 26: prediction model selecting unit, 27: demand prediction unit, 28: display data output unit, 31: data acquiring circuit, 32: data storing circuit, 33: relevance degree calculating circuit, 34: index data extracting circuit, 35: prediction model storing circuit, 36: prediction model selecting circuit, 37: demand prediction circuit, 38: display data output circuit, 41: memory, 42: processor, 51: training data acquiring unit, 52: training data storing unit, 53: training data analyzing unit, 54: learning unit, 55: evaluation unit, 61: training data acquiring circuit, 62: training data storing circuit, 63: training data analyzing circuit, 64: learning circuit, 65: evaluation circuit, 71: memory, 72: processor, 81: data acquiring unit, 82: data storing unit, 83, 84: relevance degree calculating unit, 91: data acquiring circuit, 92: data storing circuit, 93, 94: relevance degree calculating circuit

1. A demand prediction device comprising:
processing circuitry configured to
acquire demand data indicating a temporal change of a past demand in a product of a demand prediction target and index candidate data indicating each of a plurality of indexes which are candidates of an index related to the past demand;
calculate a relevance degree between at least one index indicated by each of index candidate data having been acquired and a demand indicated by the demand data having been acquired;
extract index data used for demand prediction processing for predicting a future demand of the product from among the plurality of index candidate data having been acquired on a basis of the calculated relevance degree;
perform the demand prediction processing using the extracted index data;
acquire setting data indicating a semantic similarity corresponding to a similarity degree between the at least one index indicated by each of the index candidate data and the demand indicated by the demand data in addition to the plurality of index candidate data and the demand data; and
calculate a correlation coefficient between each of the index candidate data and the demand data or a distance between each of the index candidate data and the demand data, and calculate the relevance degree between the at least one index indicated by each of the index candidate data and the demand indicated by the demand data from each correlation coefficient or each distance and the semantic similarity indicated by the setting data.

2. The demand prediction device according to claim 1, wherein the processing circuitry performs demand prediction processing of giving the index data having been extracted to a prediction model and acquiring a prediction result of the future demand of the product from the prediction model.

3. The demand prediction device according to claim 1,
wherein the processing circuitry is further configured to select a prediction model to which the index data is given from among a plurality of prediction models generated by a learning device on a basis of the acquired demand data; and
perform demand prediction processing of giving the extracted index data to the selected prediction model and acquire a prediction result of the future demand of the product from the prediction model.

4. The demand prediction device according to claim 1,
wherein the processing circuitry is further configured to generate display data for displaying a prediction result of the demand and output the display data.

5. The demand prediction device according to claim 1, wherein the processing circuitry extracts top M (M is an integer of 1 or more) pieces of index candidate data having a high relevance degree having been calculated as the index data used for the demand prediction processing from among the plurality of index candidate data having been acquired.

6. The demand prediction device according to claim 1, wherein the processing circuitry acquires index candidate data indicating an index other than an economic index as the plurality of index candidate data in addition to the index candidate data indicating an economic index.

7. The demand prediction device according to claim 6, wherein
the plurality of index candidate data include index candidate data indicating each of a plurality of economic indexes and index candidate data indicating each of a plurality of indexes other than the economic indexes, and
the processing circuitry extracts the index data used for the demand prediction processing from among the index candidate data each indicating each of the plurality of economic indexes on a basis of the calculated relevance degree, and extracts the index data used for the demand prediction processing from among the index candidate data each indicating each of a plurality of indexes other than the economic indexes.

8. A demand prediction method comprising:
acquiring demand data indicating a temporal change of a past demand in a product of a demand prediction target and index candidate data indicating each of a plurality of indexes which are candidates of an index related to the past demand;
calculating a relevance degree between at least one index indicated by each of index candidate data having been acquired and a demand indicated by the demand data having been acquired;
extracting index data used for demand prediction processing for predicting a future demand of the product from among the plurality of index candidate data having been acquired on a basis of the calculated relevance degree;
performing the demand prediction processing using the extracted index data;
acquiring setting data indicating a semantic similarity corresponding to a similarity degree between the at least one index indicated by each of the index candidate data and the demand indicated by the demand data in addition to the plurality of index candidate data and the demand data;
calculating a correlation coefficient between each of the index candidate data and the demand data or a distance between each of the index candidate data and the demand data;
calculating the relevance degree between the at least one index indicated by each of the index candidate data and the demand indicated by the demand data from each correlation coefficient or each distance and the semantic similarity indicated by the setting data.
